(19) United States
(12) Patent Application Publication
(10) Pub. No.: US 2016/0223736 A1
(43) Pub. Date: Aug. 4, 2016

(54) APPARATUS FOR DISPLAY SYSTEMS

(71) Applicant: CORPORATION FOR LASER OPTICS RESEARCH, Portsmouth, NH (US)

(72) Inventors: Masayuki KARAKAWA, Newmarket, NH (US); David GIROUX, Durham, NH (US)

(73) Assignee: DOLBY LABORATORIES LICENSING CORPORATION, San Francisco, CA (US)

(21) Appl. No.: 14/890,425

(22) PCT Filed: Mar. 14, 2014
(86) PCT No.: PCT/US14/27789

§ 371 Date: Nov. 10, 2015

Related U.S. Application Data
(60) Provisional application No. 61/793,213, filed on Mar. 15, 2013.

(51) Int. Cl. F21V 8/00; G02B 27/48

(52) U.S. Cl. CPC G02B 6/0036; G02B 6/0068; G02B 6/0065; G02B 6/002; G02B 6/0055; G02B 27/48

(57) ABSTRACT

Apparatus for use in display systems are disclosed. In certain implementations, a display apparatus includes a light guide plate for use in a liquid crystal display backlight system. In other implementations, an apparatus for use in a projection display is disclosed including a substantially transparent rectangular prism. In implementations including laser-based light sources, the light guide plate or substantially transparent rectangular prism is configured to reduce the spatial coherence of laser light introduced thereto, thereby reducing speckle. The light guide or prism includes a plurality of light scattering particles suspended therein; alternatively the light guide or prism has a set of scratches on a surface thereof, rending the surface substantially opaque.

### RELATED APPLICATIONS

This application claims priority to U.S. Provisional Patent Application No. 61/793,213, entitled “Apparatus For Display Systems,” and filed on Mar. 15, 2013, the entirety of which is hereby incorporated by reference.

### BACKGROUND

Laser light sources have inherently narrow band and give rise to the perception of fully saturated colors. However, laser light sources have high temporal and spatial coherence, causing speckle like patterns substantially limiting their use in both projection and flat panel displays.

### SUMMARY OF THE INVENTION

In one aspect, the disclosure is related to a display apparatus that includes a light guide plate having a plurality of light scattering particles suspended within the light guide plate. The display apparatus contains a laser positioned along a first edge of the light guide plate for introducing laser light into the light guide plate. The laser array can include a plurality of lasers of at least one primary color. Each of the lasers in the array can have a FWHM bandwidth greater than about 0.1 nm. In addition, the display apparatus can include an array of light modulators to modulate the light emitted from the light guide plate to form an image on the display apparatus.

In some implementations, the light guide plate includes an acrylic material, such as poly Methyl Methacrylate (PMMA). The light scattering particles can be randomly dispersed within the light guide plate to create random scattering of the laser light to substantially destroy the spatial coherence of the laser light prior to its exit through an output end of the light guide plate. The light guide plate can further include a cut-out pattern along a first edge. Uniformity Tape can be coupled to the first edge of the light guide plate.

The display apparatus can include a plurality of side reflectors positioned adjacent to at least a second edge of the light guide plate. The display apparatus can also include a back reflector positioned adjacent to a back surface of the light guide plate. The lasers in the laser array can include semiconductor diode lasers. At least two of the lasers in the array can be of a common primary color and can have center wavelengths that are shifted with respect to one another.

The light guide plate can have a range of transmissiveness based upon the density of the light scattering particles in the light guide plate. The density of the light scattering particles are selected so that the transmissiveness of the light guide plate is between about 80% and about 95%. In other implementations, the density of the light scattering particles are selected so that the transmissiveness of the light guide plate is between about 91% and about 93%. At least one LED light source can be positioned along an edge of the light guide plate for introducing light of at least a second primary color into the light guide plate.

In another aspect, a display apparatus includes a light guide plate having a back surface incorporating a set of scratches which render at least a majority of the area of the back surface substantially opaque. The display apparatus can include a laser array positioned along a first edge of the light guide plate for introducing laser light into the light guide plate. The laser array can include a plurality of lasers of at least one primary color. Each of the lasers in the array can have a FWHM bandwidth greater than about 0.1 nm. The display apparatus can include an array of light modulators to modulate the light emitted from the light guide plate to form an image. The light guide plate can include an acrylic material, such as poly Methyl Methacrylate (PMMA).

In some implementations, the set of scratches have a substantially random arrangement across the back surface of the light guide to substantially destroy the spatial coherence of the laser light prior to its exit through an output end of the light guide plate. The light guide plate further includes a border region along the first edge, having a width of about 10 mm and about 25 mm and substantially free of scratches. The first edge can also include a cut-out pattern.

The display apparatus can include a plurality of side reflectors positioned adjacent to at least a second edge of the light guide plate. In addition, the lasers in the laser array can include a plurality of semiconductor diode lasers. At least two of the lasers in the array can be of a common primary color and can have center wavelengths that are shifted with respect to one another. Uniformity Tape can be coupled to the first edge of the light guide plate. At least one LED light source can be positioned along an edge of the light guide plate for introducing light of at least a second primary color into the light guide plate.

According to one aspect of the disclosure, a method for producing a display backlight can include obtaining a light guide plate and scratching the rear of the light guide plate using an abrasive material such that the resulting scratches render at least the majority of the rear surface of the light guide plate substantially opaque. In addition, the method can include positioning a laser array adjacent to a first edge of the light guide plate to introduce laser light into the light guide plate. The laser array can include a plurality of lasers of at least one primary color. Each of the lasers in the array can have a FWHM bandwidth greater than about 0.1 nm.

The method can further include scratching the rear surface of the light guide plate in a circular motion. Furthermore, the scratching can be done by applying a fine grade 150 grit sandpaper. The scratches can be randomly dispersed throughout the back surface to substantially destroy the spatial coherence of the laser light prior to its exit through an output end of the light guide plate.

The method for producing a display backlight can include creating a border region, substantially free of scratches along the first edge and having a width of between about 10 mm and about 25 mm. The method can include creating a cut-out pattern along the first edge of the light guide plate. The method can also include positioning a plurality of side reflectors adjacent to a second edge of the light guide plate. In addition, the method can include positioning a back reflector adjacent to the back surface of the light guide plate. The method can also include applying Uniformity Tape to the first edge of the light guide plate.

In one implementation, the disclosure is related to an apparatus for use in a projection display. The apparatus for use in a projection display can include a substantially transparent rectangular prism having an input end, an output end, four sides, and a plurality of light scattering particles suspended within in its interior. The apparatus can further include a plurality of side reflectors, each positioned adjacent to one of the sides of the rectangular prism and a laser array configured to output spatially coherent laser light of at least one color into the input end of the rectangular prism. The laser array can include a plurality of lasers of at least one primary color. Each of the lasers in the array can have a FWHM bandwidth greater than about 0.1 nm. The plurality of light scattering particles can be configured to substantially destroy the spatial coherence of the laser light prior to its exit through the output end of the rectangular prism. In addition, the scattering particles can be randomly dispersed within the rectangular prism to create random scattering.

The apparatus for use in a projection display can include a relay optic to transfer the laser light received from the substantially transparent rectangular prism within an acceptable uniformity. The rectangular prism can include an acrylic material, such as poly Methyl Methacrylate (PMMA). The input end and the output end of the rectangular prism can be polished. Further, the lasers in the laser array can include a plurality of semiconductor diode lasers. At least two of the lasers in the array can be of a common primary color and can have center wavelengths that are shifted with respect to one another. The substantially transparent rectangular prism can have a range of transmissiveness, which can be based upon the density of the light scattering particles. The density of the light scattering particles can be selected such that the rectangular prism has a transmissiveness of between about 80% and about 95%. In another implementation, the density of the light scattering particles is selected such that the rectangular prism has a transmissiveness of between about 91% and about 93%.

In another aspect, an apparatus for use in a projector display can include a substantially transparent rectangular prism having an input end, an output end, four sides and a set of scratches which render at least a majority of the surface of the four side substantially opaque. The apparatus can further include a plurality of side reflectors, each positioned adjacent to one of the sides of the rectangular prism and a laser array configured to output spatially coherent laser light of at least one color into the input end of the substantially transparent rectangular prism. The laser array can include a plurality of lasers of at least one primary color. Each of the lasers in the array can have a FWHM bandwidth greater than about 0.1 nm. The rectangular prism includes an acrylic material, such as poly Methyl Methacrylate (PMMA).

The apparatus can include a relay optic to transfer the laser light received from the substantially transparent rectangular prism within an acceptable uniformity.

The set of scratches can be configured to substantially destroy the spatial coherence of the laser light prior to its exit through the output end of the rectangular prism. They can have a substantially random arrangement across the four sides of the substantially transparent rectangular prism.

The lasers in the laser array can include semiconductor diode lasers. At least two of the lasers in the array can be of a common primary color and can have center wavelengths that are shifted with respect to one another.

Further features and advantages of the present disclosure will be apparent from the following description of preferred embodiments and from the claims.

### BRIEF DESCRIPTION OF THE DRAWINGS

The following figures depict certain illustrative embodiments of the disclosure in which like reference numerals refer to like elements. These depicted embodiments are to be understood as illustrative of the disclosure and not as limiting in any way.

FIG. 1 shows schematically the layers of a liquid crystal display (LCD) screen;

FIG. 2A shows schematically the spectral emission and the ensemble spectrum of five exemplary lasing elements having a mean spectral overlap parameter γ>1;

FIG. 2B shows schematically the spectral emission and the ensemble spectrum of five exemplary lasing elements having a mean spectral overlap parameter γ=1;

FIG. 3A shows schematically an illustrative configuration for a backlight for a LCD display according to an illustrative embodiment of the disclosure;

FIG. 3B shows schematically an illustrative configuration for a second backlight for a LCD display according to an illustrative embodiment of the disclosure;

FIG. 3C shows schematically an illustrative configuration for a third backlight for a LCD display according to an illustrative embodiment of the disclosure;

FIG. 4 shows schematically a method for producing a display backlight;

FIG. 5 shows schematically an illustrative configuration for a Digital Light Process (DLP) projector with a laser light source according to an illustrative embodiment of the disclosure;

FIG. 6A shows schematically an illustrative configuration for a first integrator rod for use in a projection display according to an illustrative embodiment of the disclosure;

FIG. 6B shows schematically an illustrative configuration for a second integrator rod for use in a projection display according to an illustrative embodiment of the disclosure;

FIG. 6C shows schematically an illustrative configuration for a third integrator rod for use in a projection display according to an illustrative embodiment of the disclosure;

### DETAILED DESCRIPTION OF CERTAIN ILLUSTRATED EMBODIMENTS

To provide an overall understanding of the disclosure, certain illustrative implementations will now be described, including a bandwidth-enhanced laser light source for flat-panel and projection displays, such as liquid crystal displays (LCDs) or Digital Light Processing (DLP) projection display. However, it will be understood by one of ordinary skill in the art that the apparatus described herein may be adapted and modified as is appropriate for the application being addressed and that the systems and methods described herein may be employed in other suitable applications, and that such other additions and modifications will not depart from the scope hereof.

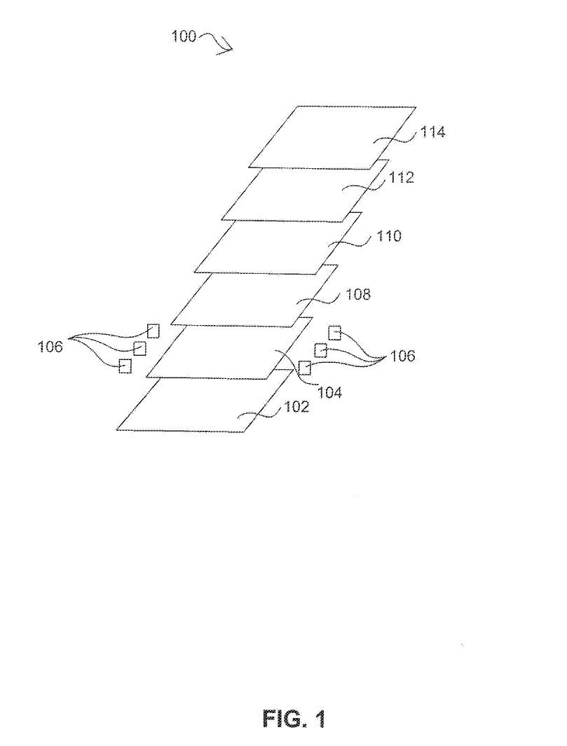

FIG. 1 shows schematically the layers of a liquid crystal display (LCD) 100, according to an illustrative embodiment of the disclosure. At the back is a reflector 102 for directing light toward the front of the display. Light from the reflector passes through a light guide 104, usually made of molded transparent or white plastic. In one implementation, the light guide 104 has a plurality of microlenses molded into its surface to aid in extracting light at predetermined points. Positioned adjacent to the light guide 104 are laser assemblies 106, which provide light for the display. The laser assemblies 106 emit light into the light guide, which then distributes the light across the display. The light guide also serves to mix the light from the various laser assemblies to achieve a generally white light source. The laser assemblies may be arranged around the light guide in various configurations. From the light guide 104, light passes through a diffuser sheet 108, which further diffuses light across the display. In front of the diffuser sheet 108 are two optical films, a brightness enhancing film 110 for directing light toward the viewer (for example, BEF II-T, which can be obtained under the brand name Vikuiti from 3M, headquartered in St. Paul, Minn.), and a polarizing film 112 (for example, DBEF II, which can also be obtained from 3M under the brand name Vikuiti). After being polarized, light extracted from the light guide 104 illuminates an LCD panel 114. LCD panels can be obtained, for example, from Sharp (headquartered in Osaka, Japan) and Samsung (headquartered in Seoul, Korea).

In some implementations, a quantum dot enhancement film (referred to as a QDEF film) can be positioned between the light guide 104 and the diffuser sheet 108. In such implementations, the LCD display can be illuminated by an array of blue lasers. Characteristics of certain examples of such a laser array are discussed below. The QDEF film converts a portion of the blue light emitted by the lasers into red and green light. Together, the red and green light emitted by the QDEF film and the remaining blue light not converted by the QDEF film yield white light for modulation by the LCD panel 114.

Laser illumination typically results in image speckle. However, as disclosed in U.S. Pat. No. 6,975,294, entitled Systems and Methods for Speckle Reduction through Bandwidth Enhancement, laser light sources formed from multiple lasers with certain frequency and bandwidth characteristics reduce if not eliminate speckle. The parameters for designing a bandwidth-enhanced laser array (BELA) include the number n of emitters in the array, the center wavelength λ₀ᵢ of each emitter, the spectral separation Sᵢ between the center wavelength λ₀ᵢ, of an emitter j and the center wavelength Δλⱼ of an emitter j being closest in wavelength, the respective bandwidth Δλᵢ of the individual emitters, and the relative output power Aᵢ of each emitter.

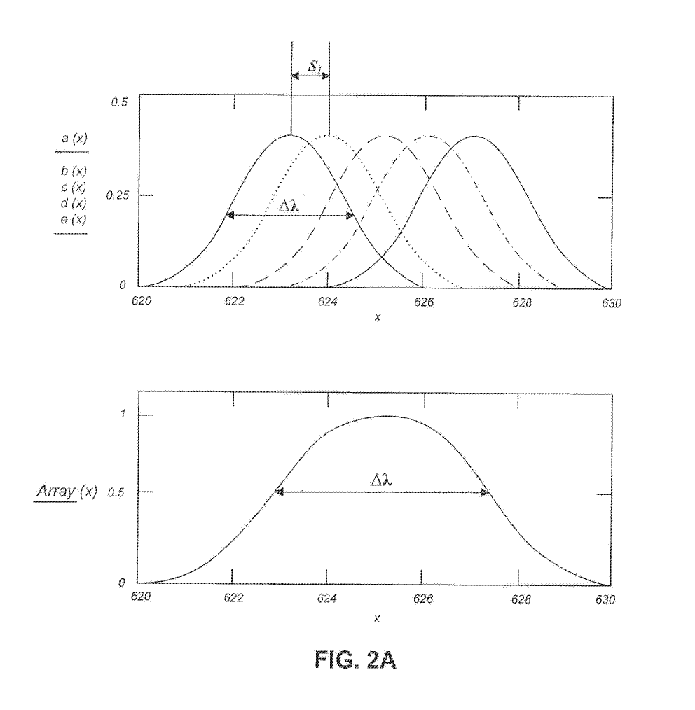

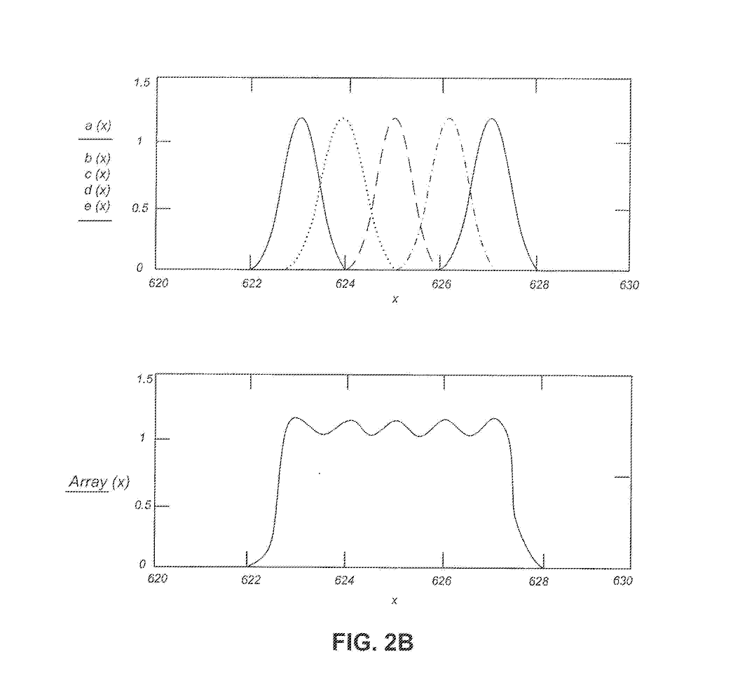

FIGS. 2A and 2B depict the frequency and bandwidth characteristics of example laser light sources suitable for use in the LCD display of FIG. 1. Specifically, FIGS. 2A and 2B depict ensemble spectra of bandwidth-enhanced laser light produced from an array of spatially separated, discrete emitters of laser radiation. Each emitter has a respective spectral bandwidth Δλ_{I} centered at some arbitrary red, green or blue wavelength λ₀ᵢ. The emitters of a particular color of laser light are designed to have slightly different central wavelengths, thereby creating an ensemble bandwidth ΔΛ which is greater than the bandwidth Δλᵢ of any individual emitter. By engineering the amount of ensemble bandwidth ΔΛ required for the cancellation of speckle, the quasi-monochromatic property responsible for the appearance of fully-saturated color is preserved. A mean spectral overlap parameter γ≡Δ̅λ̅ᵢ̅/S̅ᵢ̅, where Δ̅λ̅ᵢ̅ is the mean spectral bandwidth of the emitters and S̅ᵢ̅ is the mean wavelength shift between center wavelengths as described above, can be associated with the ensemble wavelength characteristic of an array of emitters of a particular color. In a first scenario with γ>1, shown in FIG. 2A, there exists substantial overlap in the spectra from the individual emitters (top FIG. 2A). The resulting ensemble spectrum Λ is a smoothly varying function of wavelength and virtually free of any spectral features from the individual emitters (bottom FIG. 2A). This condition may be considered “ideal” for bandwidth enhancement since the spectral averaging that occurs produces a uniformly broadened distribution for γ>>1 and a large number of emitters, thereby minimizing speckle.

For γ=1, as depicted in FIG. 2B, the ensemble spectrum Λ shown at the bottom of FIG. 2B becomes a rippled function with local maxima coincident with the central wavelengths λ₀ᵢ of the individual emitters. Values of γ less than 1 have been found to be less efficient for reducing speckle than values of γ greater than 1. Simulations using Fourier analysis suggest that coherent interference may be even more effectively suppressed with a non-uniform distribution of emitter intensities, with the possibility of eliminating speckle noise altogether.

Compared to traditional cold cathode fluorescent lamps (CCFLs) or recently available light emitting diodes (LEDs), the lasers, generally speaking, can provide a more saturated and expanded color gamut which is fully compatible with the xvYCC and the UHDTV standard or for extended color space for moving pictures. The lasers can also provide highly-polarized and well-collimated beams which aid to increase the transmission efficiency and/or image contrast.

The above laser light source designs for the disclosed displays, on the other hand, utilize the aforementioned increased spectral bandwidth of an array of laser emitters to reduce speckle directly at the laser source by disrupting the temporal coherence of the emitted laser light. This is particularly beneficial when used in combination with the liquid crystal flat panels because these flat panel displays usually do not have enough space (i.e. depth) to adopt additional de-speckling optics or devices.

Speckle can also be reduced in displays by disrupting the spatial coherence of the emitted laser. For flat panel displays, the spatial coherence can be disrupted within the display backlight. In projection displays, the spatial coherence can be disrupted within integrator rods or other optical components included in the projection device. In some laser-based display devices, disruption of spatial coherence of the laser light may, by itself, be sufficient to satisfactorily remove speckle. Accordingly, in some implementations, the displays that incorporate spatial coherency disrupting optical components can include laser arrays other than the above-described BELA light sources. For example, the laser light for a given primary color may be provided by array of two or more lasers of that color each having a full width at half maximum (FWHM) bandwidth of at least about 0.1 nm, for example between about 0.1 nm and about 1 nm. At least two of the lasers in the array may also include different center wavelengths. In some other implementations, a disruption of the spatial coherence of the laser light can diminish the degree to which the temporal coherence of the laser light needs to be disrupted to obtain an acceptably low level of speckle. In some such implementations, a display combines a spatial coherency disrupting optical component with a BELA with a γ value that is closer to 1 than might be desired if the spatial coherency reducing optical component were not included.

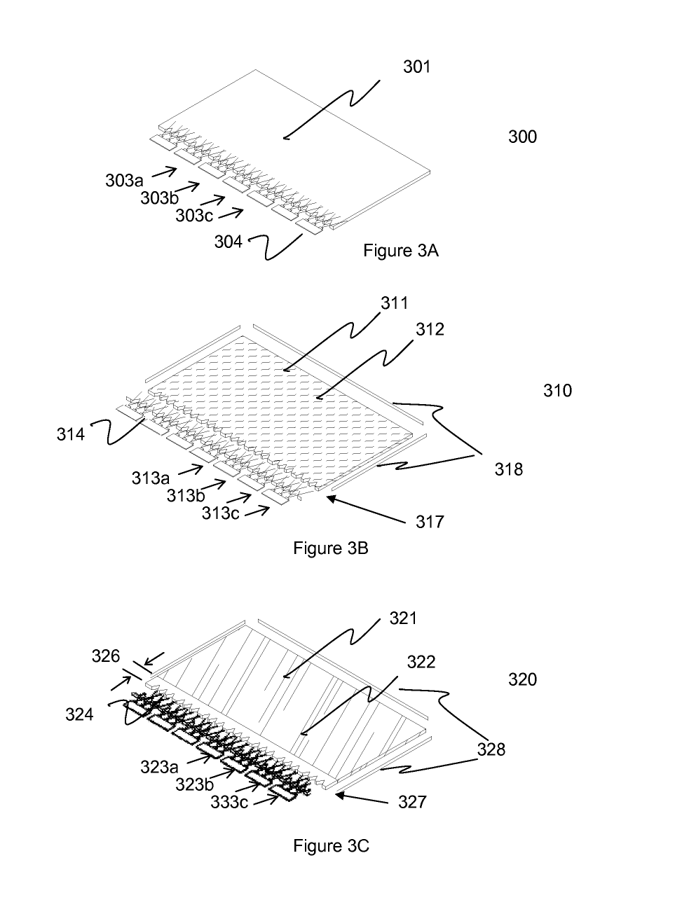

FIG. 3A is a first schematic diagram of a liquid crystal display backlight 300. The backlight 300 can be used for example in the display shown in FIG. 1. The Backlight 300 includes a light guide plate 301, a series of semiconductor diode laser arrays 303. The semiconductor diode laser array 303 can be the laser light sources described in relation to FIG. 1 and FIG. 2. The light guide plate 301 is formed from a transparent material such as an acrylic, for example and without limitation, poly Methyl Methacrylate. The light guide plate 301 is an edge-lit light guide plate and receives light from the plurality of semiconductor diode laser arrays 303, positioned along a first edge 304 of the light guide plate 301. The semiconductor diode laser arrays 303 introduce at least one primary color to the light guide plate 301, such as red, green or blue. In some implementations, the semiconductor diode laser arrays introduce multiple colors. In some other implementations, one or more other colors are provided by light emitting diodes.

FIG. 3B is a schematic diagram of another backlight 310 for use in a LCD display. In FIG. 3B, the backlight includes a particle-filled light guide plate 311 and a series of semiconductor diode laser arrays 313. The semiconductor diode laser array 313 can be similar to the laser light sources described in relation to FIG. 1 and FIG. 2. The particle-filled light guide plate 311 is formed from a clear plastic, such as an acrylic material, for example and without limitation, poly Methyl Methacrylate. The particle-filled light guide plate 311 includes a plurality of scattering particles 312 suspended within it. The plurality of scattering particles 312 are randomly dispersed within it to create random scattering of laser light received from the semiconductor diode laser arrays 313, in order to substantially destroy the spatial coherence of the laser light prior to its exit through an output surface of the particle light guide plate 311.

In one implementation, the backlight 310 is an edge-lit backlight. The semiconductor diode laser arrays 313 output light of at least one color and are positioned along a first edge 314 of the particle-filled light guide 311. The semiconductor diode laser arrays 313 introduce laser light of the at least one color into the particle-filled light guide plate 311. The at least one color may include a primary color. For example, the at least one color can be red, blue or green. The semiconductor diode laser arrays can introduce multiple colors of light. Alternatively, additional colors can be introduced by LEDs.

The particle-filled light guide plate 311 includes a cut-out pattern 317 along the first edge 314 of the particle-filled light guide plate 311. The cut-out pattern 317 includes edges of various shapes, including for example and without limitation, square, V-shaped, round and spherical shaped edges. The cut-out pattern aids in effective color mixing of the laser light. The cut-out pattern 317, is selected based upon the beam divergence characteristics of the semiconductor diode laser array 313. The cut out pattern is used to promote color mixing within the light guide plate 311. A similar result can be achieved without the cutout pattern by applying Uniformity Tape (provided by 3M Corporation) to first edge 314.

Backlight 310 includes a plurality of side reflectors 318 positioned adjacent to at least a second edge of the particle-filled light guide plate 311. The side reflectors direct laser light leaving the particle-filled light guide plate 311 along its other edges back into the particle-filled light guide plate 311. In some implementations, the plurality of side reflectors are separated from the edges of the particle-filled light guide plate 311 by a predetermined distance, typically within 1 wavelength of the semiconductor diode laser array with the smallest average wavelength. In some other implementations, the plurality of side reflectors are attached directly to the edges of the particle-filled light guide plate 311. Further, the backlight 310 includes a back reflector positioned adjacent to a back surface of the particle-filled light guide plate 311 for directing light towards the front of a display. The back reflector is separated from the back surface of the particle light guide plate 311 by a pre-determined distance, typically within 1 wavelength of the semiconductor diode laser array with the smallest average wavelength. In some implementations, the back reflector may be attached directly to the back surface of the particle-filled light guide plate 311.

The particle-filled light guide plate 311 can have a range of transmissiveness levels, which is determined primarily based upon the density of the light scattering particles suspended within the particle-filled light guide plate 311. In some implementations, the transmissiveness ranges between about 80% and about 95%. Experimental data suggests improved optical performance using particle-filled light guide plates 311 having densities of light scattering particles that yield transmissiveness levels between about 91% and about 93%.

The backlight 310 outputs light to an array of light modulators. The light modulators may include liquid crystal cells and modulate the light received from the backlight 310 to form an image on a display.

FIG. 3C is a schematic diagram of another backlight 320 for use in an LCD display. The backlight 320 includes a scratched light guide plate 321 and a series of semiconductor diode laser arrays 323. The scratched light guide plate 321 is formed from a clear plastic, such as an acrylic material, for example and without limitation, poly Methyl Methacrylate. The scratched light guide plate 321 includes a back surface incorporating a set of scratches 322 which render at least a majority of the area of the back surface substantially opaque. In some implementations, the set of scratches 322 renders a majority of the area of the sides of the scratched light guide plate 321 substantially opaque too. The set of scratches 322 have a substantially random arrangement across the back surface of the scratched light guide plate 321 to substantially destroy the spatial coherence of the laser light prior to its exit through an output surface of the scratched light guide plate 321, which faces an array of light modulators. The set of scratches 322 create random scattering of the laser light received from the semiconductor diode laser arrays 323.

In one implementation, the backlight 320 is an edge-lit backlight. The semiconductor diode laser arrays 323 output light of at least one color and are positioned along a first edge 324 of the scratched light guide 321. The semiconductor diode laser arrays 323 introduce laser light of the at least one color into the scratched light guide plate 321. The at least one color may include a primary color. For example, the at least one color can be red, blue or green. The semiconductor diode laser arrays 323 can introduce multiple colors of light. Alternatively, additional colors can be introduced by LEDs.

The scratched light guide plate 321 includes a border region 326 along the first edge 324 that is substantially free of scratches. The border region 326 has a width of between about 10 mm and about 25 mm for improved color mixing. The borer region 326 along the first edge 324 is positioned adjacent to the cut-out pattern 327. The cut-out pattern 327 includes edges of various shapes, including for example and without limitation, square, V-shaped, round and spherical shaped edges. The cut-out pattern aids in effective color mixing of the laser light. The cut-out pattern 327, is selected based upon the beam divergence characteristics of the semiconductor diode laser array 313. A similar result can be achieved without the cutout pattern by applying Uniformity Tape (provided by 3M Corporation) to first edge 324.

The backlight 320 includes a plurality of side reflectors 328 positioned adjacent to at least a second edge of the scratched light guide plate 321. The side reflectors direct laser light leaving the scratched light guide plate 321 along its other edges back into the scratched light guide plate 321. In some implementations, the plurality of side reflectors 328 are separated from the edges of the scratched light guide plate 321 by a predetermined distance, typically within 1 wavelength of the semiconductor diode laser array with the smallest average wavelength. In some other implementations, the plurality of side reflectors 328 are attached directly to the edges of the scratched light guide plate 321.

The backlight 320 outputs light to an array of an array of light modulators. The light modulators may include liquid crystal cells and modulate the light received from the backlight 320 to form an image on a display.

While each of the backlights 300, 310, and 320 shown in above in FIGS. 3A-3C are described as including arrays of semiconductor lasers, in other implementations, other types of lasers having bandwidths ranging from about 0.1 nm to at least about 1.0 nm may be employed instead.

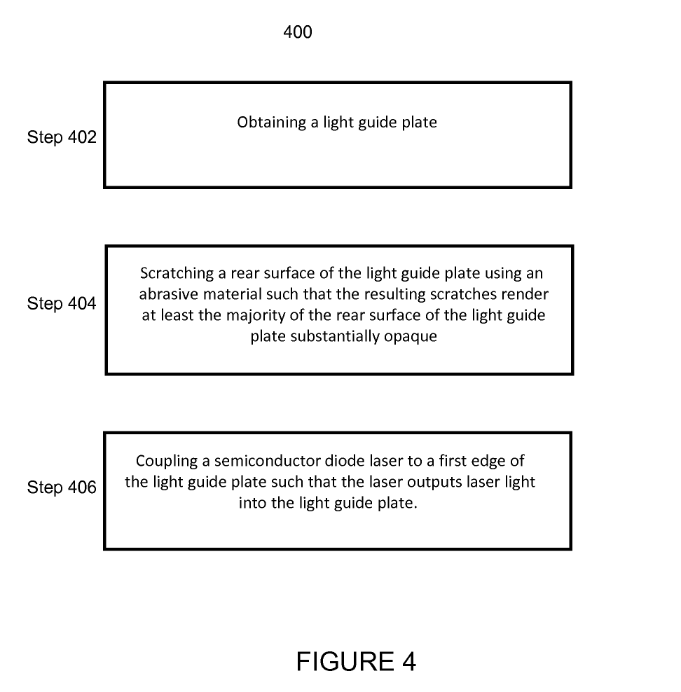

FIG. 4 illustrates a method for producing a display backlight 400 that includes a scratched light guide plate. The method 400 includes obtaining a light guide plate (Step 402), scratching a rear surface of the light guide plate using an abrasive material such that the resulting scratches render at least the majority of the rear surface of the light guide plate substantially opaque (Step 404), positioning a laser array adjacent to a first edge of the light guide plate such that the laser outputs laser light into the light guide plate (Step 406). The laser array can include semiconductor lasers or other lasers having a bandwidth of between about 0.1 and at least about 1.0 nm.

Referring further to FIG. 4, and in more detail, a light guide plate is obtained (Step 402). The light guide plate can be formed from a clear plastic, such as an Acrylic, e.g., poly Methyl Methacrylate (PMMA). The light guide may have a pattern cut out of one of its edges.

Upon obtaining the light guide plate, a rear surface of the light guide plate is scratched using an abrasive material such that the resulting scratches render at least the majority of the rear surface of the light guide plate substantially opaque (Step 404). In some implementations, the scratching of the rear surface is done in a circular motion. In still other implementations, the scratching of the surface is done in a random motion. In yet another implementation, the scratching of the surface is done in a pre-determined pattern. The abrasive material used to scratch the rear surface can be a fine grade sandpaper having a grit classification ranging from 80 grit to 220 grit. In one implementation, the abrasive material is a fine grade 150 grit sandpaper. In other implementations, other similarly abrasive surfaces can be employed to scratch the rear surface of the light guide plate. The scratches are randomly dispersed throughout the back surface to substantially destroy the spatial coherence of the laser light prior to its exit through an output surface of the light guide plate.

Still referring to FIG. 4, the method for producing a display backlight further includes preserving a border region along the first edge, i.e., the edge with the cut-out pattern where the laser array will be placed. The border region has a width of about 10 mm to about 25 mm. The border region is substantially free of scratches. In implementations in which the light guide plate is not obtained having a cut-out pattern, the method can include forming the cut-out pattern as described above in relation to FIG. 3A-3C.

In addition, the method for producing a display backlight can include positioning a plurality of side reflectors adjacent to at least a second edge of the light guide plate. In one implementation, a plurality of side reflectors are positioned adjacent to a plurality of edges of the light guide plate.

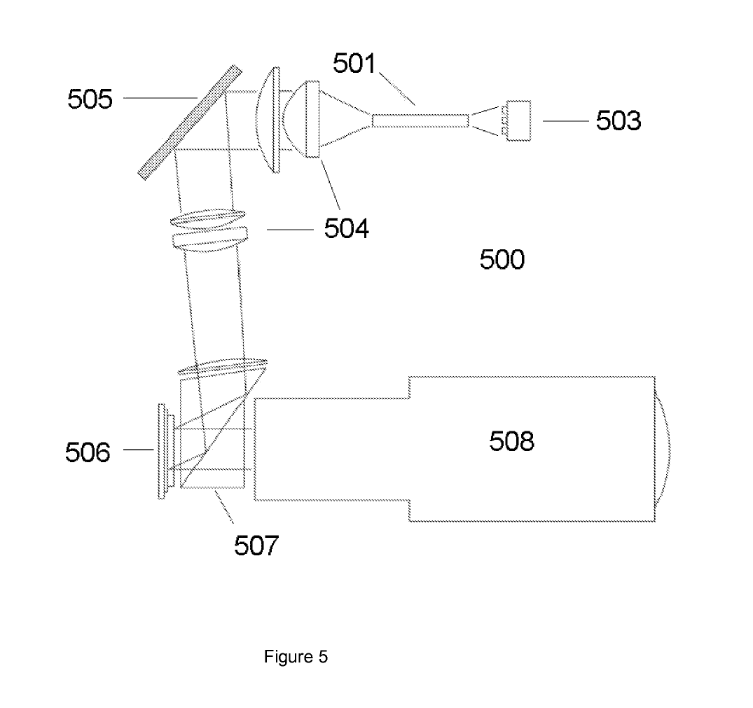

FIG. 5 is schematic diagram of a Digital Light Processing (DLP) Projector 500 that includes a laser light source. In one configuration, the DLP projector 500 includes a semiconductor diode laser array 503 similar to the arrays described in relation to FIGS. 1 and 2, positioned adjacent to an integrator rod 501. The semiconductor diode laser array 503 introduces a laser light of at least one color into a input end 504 of the integrator rod 501. In some implementations, the DLP projector 500 includes a plurality of semiconductor diode lasers 503 positioned adjacent to the integrator rod 501. Positioned adjacent to the output end of the integrator rod 501 is a first relay optic 504 configured to receive laser light output from the integrator rod 501. The first relay optic 504 transfers light to a fold mirror 505, which then transfers the light to a second relay optic 504. The combination of the fold mirror 505, first relay optic 504 and the second relay optic 504 can transfer the light received from the integrator rod 501 with an acceptable uniformity to a digital micromirror device (DMD) 506, which modulates light to form an image. In other implementations, other light modulators, such as liquid crystal on silicon (LCOS) or transmissive LCD light modulators, can employed instead of a DMD. The combination of the fold mirror 505, and the first and second relay optic 504 can transfer the light received from the integrator rod 501 in order to match a numerical aperture of the integrator rod 501 to a numerical aperture of the DLP projector 500.

Once the laser light is received by the DMD 506, the DMD 506 modulates the received laser light and transfers it to a total internal reflectance (TIR) prism 507. The TIR prism 507 can separate the illumination and projection paths of the laser light. Further the TIR prism 507 can introduce the laser light to a projector lens 508. The projector lens 508, in one implementation, can magnify the image for display on a screen.

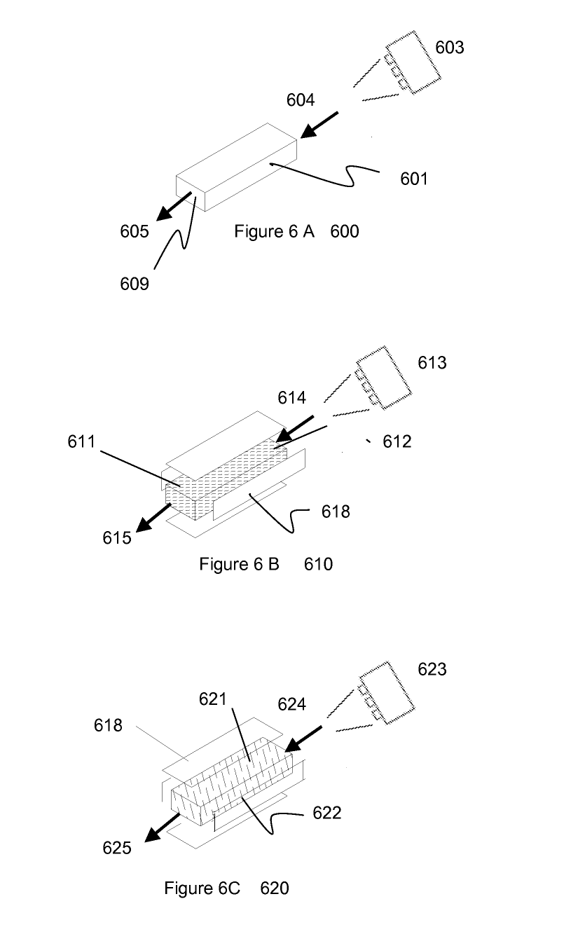

FIG. 6A is a schematic diagram of a first integrator rod 600, for use in a projection display, such as the DLP projector 500 of FIG. 5. The integrator rod includes a substantially transparent rectangular prism 601. The rectangular prism 601 is formed from a transparent material such as an Acrylic, e.g., poly Methyl Methacrylate (PMMA). The rectangular prism 601 includes an input end 604 and an output end 605. The input end 604 can receive light. For example, the input end 604 can receive light from a semiconductor diode laser array such as the arrays described in relation to FIGS. 1 and 2 or any other array of lasers in which the bandwidth of each emitter has a bandwidth greater than about 0.1 nm, e.g., between 0.1 nm and about 1.0 nm. The output end 605, can introduce light to relay optics to reach an array of light modulators, such as the DMD 506 shown in FIG. 5.

In one configuration, the input end 604 and output end 605 are clear. In some implementations, the input end 604 and output end 605 are polished. The input end 604 and the output end 605 can have an aspect ratio, including at least one of: 4:3, 16:9, and 2:1. The aspect ratio of the output end 605 is selected in order to match the aspect ratio of the DLP projector, such as the DLP projector 500 shown in FIG. 5. Further, the input end 604 and the output end 605 can be coated with an anti-reflective coating to reduce the reflection of light entering and exiting, respectively.

FIG. 6B is a schematic of another integrator rod 610 for use in a projection display. The integrator rod 610 is formed from a substantially transparent particle-filled rectangular prism 611 and a plurality of side reflectors 618. The particle-filled rectangular prism 611 is formed from a transparent material, such as an Acrylic, e.g., poly Methyl Methacrylate (PMMA). The particle-filled rectangular prism 611 can have an input end 614 and an output end 615, four sides and a plurality of light scattering particles 612 suspended within the interior of the particle-filled rectangular prism 611. The scattering particles 612 are randomly dispersed within the particle-filled rectangular prism 611 to create random scattering of laser light received from a laser array, e.g., any of the laser arrays described above. The scattering particles 612 are configured to substantially destroy the spatial coherence of the laser light prior to its exit through the output end 615 of the particle-filled rectangular prism 611.

The input end 614 and output end 615 of the particle-filled rectangular prism 611 are clear. In some implementations, the input end 614 and output end 615 are polished. The input end 614 and the output end 615 can have an aspect ratio, for example and without limitation, 4:3, 16:9, or 2:1. The aspect ratio of at least the output end 615 is selected to match the aspect ratio of the projection display. The input end 614 and out end 615 can be coated with an anti-reflective coating. The light exiting through the output end 615 may be received by a first relay optics 504, such as that described in relation to FIG. 5. The first relay optics 504 can transfer the light received from the particle-filled rectangular prism 611 in such a way to have it match a numerical aperture of the DLP projector 500.

As indicated above, the integrator rod 610 includes a plurality of side reflectors 618. The plurality of side reflectors 618 are positioned adjacent to one of the sides of the particle-filled rectangular prism 611. The plurality of side reflectors 618 are separated by a pre-determined distance from the rectangular particle prism 511, typically 1 wavelength of the laser array with the smallest average wavelength. In some implementations, the plurality of side reflectors 618 are attached directly to the sides of the particle-filled rectangular prism 611.

The particle-filled rectangular prism 611 can have a range of transmissiveness levels, which is determined based upon the density of the light scattering particles in the particle-filled rectangular prism 611. In some implementations, the density of the light scattering particles is selected such that the transmisiveness of the particle-filled rectangular prism 611 ranges from between about 80% and about 95%. In particular, experimental data suggests improved optical performance using particle-filled rectangular prism 611 having densities of light scattering particles that yield transmisiveness levels between about 91% and about 93%.

FIG. 6C is a schematic of an integrator rod 620 for use in a projection display. The integrator rod 620 is formed from a substantially transparent scratched rectangular prism 621 and a plurality of side reflectors. The scratched rectangular prism 621 is formed from a transparent material, such as an Acrylic, e.g., poly Methyl Methacrylate (PMMA). The scratched rectangular prism 621 can have an input end 624 and an output end 625, four sides and a set of scratches 622 which render at least a majority of the surface of the four sides substantially opaque. The set of scratches 622 have a substantially random arrangement across the four sides of the scratched rectangular prism 621. The set of scratches 622 can be configured to substantially destroy the spatial coherence of laser light prior to its exit through the output end 625 of the scratched rectangular prism 621.

The input end 624 and output end 625 of the scratched rectangular prism 621 are clear. In some implementations, the input end 624 and output end 625 are polished. The input end 624 and the output end 625 have an aspect ratio, for example and without limitation, of at least one of 4:3, 16:9, and 2:1. The aspect ratio of at least the output end 625 is selected to match the aspect ratio of the projection display. The input end 624 and the output end 625 can be coated with an anti-reflective coating. The light exiting through the output end 625 may be received by a first relay optics 504, such as that described in relation to FIG. 5. The first relay optics 504 can transfer the light received from the scratched rectangular prism 621 in such a way to have it match a numerical aperture of the DLP projector 500.

As indicated above, the integrator rod 620 includes a plurality of side reflectors 628. The plurality of side reflectors 628 are positioned adjacent to one of the sides of the scratched rectangular prism 621. In some implementations, the plurality of side reflectors 518 are positioned adjacent to the scratched rectangular prism 621, separated by a pre-determined distance from the scratched rectangular rod 621, typically within 1 wavelength of the wavelength of the laser with the smallest average wavelength. In some implementations, the plurality of side reflectors are attached directly to the sides of the scratched rectangular prism 621.

In some other implementations, the rectangular prism 621 can be formed from glass instead of plastic. For example, the rectangular prism 621 can be formed from BK7 glass or fused silica. As glass is quite difficult to scratch, the four sides of the rectangular prism 621 can be frosted instead. As with the above implementation, the side reflectors can be positioned adjacent the four sides of the rectangular prism.

While the disclosure has been disclosed in connection with the preferred embodiments shown and described in detail, various modifications and improvements thereon will become readily apparent to those skilled in the art. Accordingly, the spirit and scope of the present disclosure is to be limited only by the following claims.

What is claimed is:

1. A display apparatus, comprising:
a light guide plate including a plurality of light scattering particles suspended within the light guide plate;
a laser array positioned along a first edge of the light guide plate for introducing laser light into the light guide plate, wherein the laser array includes a plurality of lasers of at least one primary color, wherein each of the lasers in the array has a FWHM bandwidth greater than about 0.1 nm; and
an array of light modulators to modulate the light emitted from the light guide plate to form an image on the display apparatus.

2. The display apparatus of claim 1, wherein the light guide plate comprises an acrylic material.

3. The display apparatus of claim 2, wherein the acrylic material comprises poly Methyl Methacrylate (PMMA).

4. The display apparatus of claim 1, wherein the light scattering particles are randomly dispersed within the light guide plate to create random scattering of the laser light to substantially destroy the spatial coherence of the laser light prior to its exit through an output end of the light guide plate.

5. The display apparatus of claim 1, wherein the first edge of the light guide plate comprises a cut-out pattern.

6. The display apparatus of claim 1, comprising Uniformity Tape coupled to the first edge.

7. The display apparatus of claim 1, comprising a plurality of side reflectors positioned adjacent to at least a second edge of the light guide plate.

8. The display apparatus of claim 1, comprising a back reflector positioned adjacent a to a back surface of the light guide plate.

9. The display apparatus of claim 1, wherein the lasers in the laser array comprise semiconductor diode lasers.

10. The display apparatus of claim 1, wherein at least two of the lasers in the array are of a common primary color and have center wavelengths that are shifted with respect to one another.

11. The display apparatus of claim 1, wherein the light guide plate has a transmissiveness, and the density of the light scattering particles is selected such that the transmissiveness is between about 80% and about 95%.

12. The display apparatus of claim 1, wherein the transmissiveness of the light guide plate is between about 91% and about 93%.

13. The display apparatus of claim 1, comprising at least one LED light source positioned along an edge of the light guide plate for introducing light of at least a second primary color into the light guide plate.

14. A display apparatus, comprising:
a light guide plate comprising a back surface incorporating a set of scratches which render at least a majority of the area of the back surface substantially opaque;
a laser array positioned along a first edge of the light guide plate for introducing laser light into the light guide plate, wherein the laser array includes a plurality of lasers of at least one primary color, wherein each of the lasers in the array has a FWHM bandwidth greater than about 0.1 nm; and
an array of light modulators to modulate the light emitted from the light guide plate to form an image on the display apparatus.

15. The display apparatus of claim 14, wherein the light guide plate comprises an acrylic material.

16. The display apparatus of claim 15, wherein the acrylic material comprises poly Methyl Methacrylate (PMMA).

17. The display apparatus of claim 14, wherein the scratches have a substantially random arrangement across the back surface of the light guide to substantially destroy the spatial coherence of the laser light prior to its exit through an output end of the light guide plate.

18. The display apparatus of claim 14, wherein the back surface further comprises a border region substantially free from scratches along the first edge, the border region having a width of between about 10 mm and about 25 mm.

19. The display apparatus of claim 14, wherein the first edge of the light guide plate comprises a cut-out pattern.

20. The display apparatus of claim 14, comprising a plurality of side reflectors positioned adjacent to at least a second edge of the light guide plate.

21.-50. (canceled)
